(19) United States
(12) Patent Application Publication
(10) Pub. No.: US 2005/0093767 A1
(43) Pub. Date: May 5, 2005

(54) Dual display device

(75) Inventors: Tien Rong Lu, Tainan City (TW); Yih Chang, Jhonghe City (TW)

Correspondence Address: BIRCH STEWART KOLASCH & BIRCH, PO BOX 747, FALLS CHURCH, VA, 22040-0747, US

(73) Assignee: RiTdisplay Corporation

(21) Appl. No.: 10/974,859

(22) Filed: Oct. 28, 2004

(30) Foreign Application Priority Data
Oct. 30, 2003 (TW) 092130365
Dec. 12, 2003 (TW) 092135321
Dec. 12, 2003 (TW) 092135322

(51) Int. Cl. G09G 5/00

(52) U.S. Cl. 345/1.1

(57) ABSTRACT

A dual display device comprised a transparent substrate, a first display area and a second display area. The first display area disposed over the transparent substrate comprises a plurality of pixels and at least one active driving circuit. The pixel of the first display area sequentially comprises a first electrode, at least one first organic functional layer and a second electrode. The active driving circuit drives the pixel of the first display area. The second display area disposed over the transparent substrate comprises a plurality of pixels and at least one passive driving circuit. The pixel of the second display area sequentially comprises a third electrode, at least one second organic functional layer and a fourth electrode. The passive driving circuit drives the pixel of the second display area. The light-emitting directions of the first and second display areas are the same or opposite to each other.

### BACKGROUND OF THE INVENTION

1. Field of Invention

This invention relates to a display device and, in particular, to a dual display device, which comprises a main-display area and a sub-display area.

2. Related Art

The present electronic devices have become more compact and lightweight, so that the flat-panel displays become more important. In addition, the electronic devices comprise various applications, wherein the electronic devices with dual display devices for displaying plentiful information are one of the major features of the new generation electronic products. For example, the mobile phone may include a dual display device, which can be used as a main-display panel and a sub-display panel.

The conventional dual display device is manufactured by attaching two single display panels, such as LCD panels or organic electroluminescent (OEL) panels. With reference to FIG. 1, a conventional dual display device 2 includes a first display panel 21 and a second display panel 22. Wherein the first display panel 21 includes a transparent substrate 211, a first electrode 212, a light-emitting area 213, a second electrode 214 and a cover plate 215. The light-emitting area 213 is sandwiched between the first electrode 212 and the second electrode 214. The first electrode 212 is disposed on the transparent substrate 211, and the cover plate 215 is attached to the transparent substrate 211 with an adhesive. In addition, the second display panel 22 includes a transparent substrate 221, a third electrode 222, a light-emitting area 223, a fourth electrode 224 and a cover plate 225. The light-emitting area 223 is sandwiched between the first electrode 222 and the second electrode 224. The first electrode 222 is disposed on the transparent substrate 221, and the cover plate 225 is attached to the transparent substrate 221 with an adhesive. In this case, the cover plate 215 of the first display panel 21 is opposite to and attached to the cover plate 225 of the second display panel 22 so as to form the conventional dual display device 2.

However, since the conventional dual display device includes two cover plates 215 and 225 and two transparent substrates 211 and 221, the whole dual display device has larger size, thickness and weight, which can not match the trend towards the electronic device with more compact and lightweight. In addition, the first display panel 21 and the second display panel 22 are respectively manufactured in different processes, so that the manufacturing processes are complex and a waste of time. Moreover, the first display panel 21 and the second display panel 22 must be respectively driven.

It is therefore a subjective of the invention to provide a dual display device, which can solve the above-mentioned problems.

### SUMMARY OF THE INVENTION

In view of the foregoing, the invention is to provide a compact and lightweight dual display device.

The invention is also to provide a dual display device, which can actively drive and passively drive the two display areas thereof respectively.

To achieve the above, a dual display device of the invention comprises a transparent substrate, a first display area and a second display area. The first display area disposed on the transparent substrate comprises a plurality of pixels and at least one active driving circuit. The pixel of the first display area sequentially comprises a first electrode, at least one first organic functional layer and a second electrode. The active driving circuit drives the pixel of the first display area. The second display area disposed on the transparent substrate comprises a plurality of pixels and at least one passive driving circuit. The pixel of the second display area sequentially comprises a third electrode, at least one second organic functional layer and a fourth electrode. The passive driving circuit drives the pixel of the second display area. The light-emitting direction of the first display area is in the opposite light-emitting direction of the second display area. For example, the first display area is a top-emitting display area if the second display area is a bottom-emitting display area. Or, the first display area is a bottom-emitting display area if the second display area is a top-emitting display area.

On the other hand, the light-emitting direction of the first display area is the same with the light-emitting direction of the second display area. For example, the first display area and the second display area are both top-emitting display areas. Or, the first display area and the second display area are both bottom-emitting display areas.

In addition, at least one of the first display area and the second display area is a transparent display area. For example, the first display area is a transparent display area and the second display area is a top-emitting display area, a bottom-emitting display area or a transparent display area.

As mentioned above, the dual display device of the invention has two display areas disposed over a single transparent substrate, wherein every display area can be an independent display area, which emits light towards a single side such as a top-emitting display area or a bottom-emitting display area. In addition, the display areas can be a transparent display area, which emits light towards dual sides. The two display areas can be the main-display area and sub-display area of the dual display device, and the two display areas disposed on the transparent substrate can be actively driven and passively driven respectively. Thus, the dual display device of the invention utilizes only one transparent substrate and only one cover plate, so that the thickness of the whole device is more compact and more lightweight. Moreover, since both the display areas can be formed in the same manufacturing processes, the fabrication time can be shortened, the cost of the dual display device can be decreased, and the production yield can be increased. In brief, the dual display device of the invention is compact and lightweight, and has the features of the integrated manufacturing process and information partition. Therefore, the invention is suitable for mass production. Furthermore, the applications and values of the dual display device can be greatly expanded since the invention can actively and passively drive the two display areas.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional dual display device;

FIG. 2 is a schematic view showing a dual display device according to a first embodiment of the invention;

FIG. 3 is a schematic view showing another dual display device according to the first embodiment of the invention;

FIG. 4 is a schematic view showing another dual display device according to the first embodiment of the invention;

FIGS. 5A to 5E are schematic views showing other dual display devices according to the first embodiment of the invention;

FIG. 6 is a schematic view showing another dual display device according to the first embodiment of the invention;

FIGS. 7A and 7B are schematic views showing an application of the dual display device shown in FIG. 2;

FIG. 8 is a schematic view showing a dual display device according to a second embodiment of the invention;

FIG. 9 is a schematic view showing another dual display device according to the second embodiment of the invention, which comprises a semi-reflecting layer;

FIG. 10 is a schematic view showing another dual display device according to the second embodiment of the invention, which further comprises an insulating layer;

FIGS. 11A to 11F are schematic views showing other dual display devices according to the second embodiment of the invention, wherein the configurations of the semi-reflecting layer is described;

FIG. 12 is a schematic view showing another dual display device according to the second embodiment of the invention;

FIG. 13 is schematic view showing an application of the dual display device shown in FIG. 8;

FIG. 14 is a schematic view showing a dual display device according to a third embodiment of the invention, wherein the second display area is a top-emitting display area;

FIG. 15 is a schematic view showing another dual display device according to the third embodiment of the invention, wherein the second display area is a bottom-emitting display area;

FIG. 16 is a schematic view showing another dual display device according to the third embodiment of the invention, wherein the second display area is a transparent display area;

FIG. 17 is a schematic view showing another dual display device according to the third embodiment of the invention, which further comprises a semi-reflecting layer;

FIG. 18 is a schematic view showing another dual display device according to the third embodiment of the invention, which further comprises an insulating layer;

FIGS. 19A to 19G are schematic views showing other dual display devices according to the third embodiment of the invention;

FIG. 20 is a schematic view showing another dual display device according to the third embodiment of the invention; and

FIGS. 21A to 21C are schematic views showing an application of the dual display device shown in FIG. 14.

### DETAILED DESCRIPTION OF THE INVENTION

The present invention will be apparent from the following detailed description, which proceeds with reference to the accompanying drawings, wherein the same references relate to the same elements.

### First Embodment

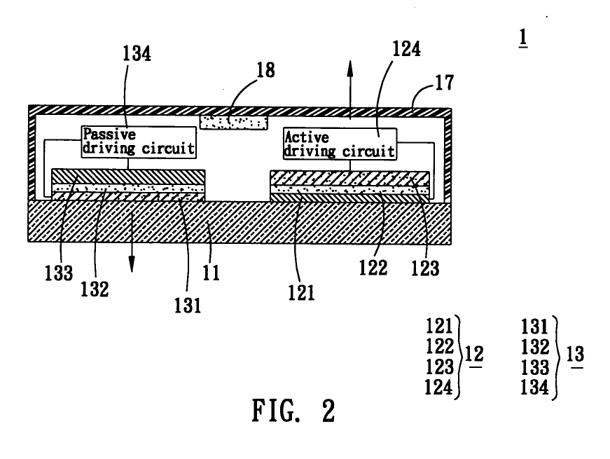

With reference to FIG. 2, a dual display device 1 according to the first embodiment of the invention comprises a transparent substrate 11, a top-emitting display area 12 and a bottom-emitting display area 13.

In this case, the top-emitting display area 12 is disposed over the transparent substrate 11 and comprises a plurality of pixels and an active driving circuit 124. The bottom-emitting display area 13 is disposed over the transparent substrate 11 and comprises a plurality of pixels and a passive driving circuit 134. The pixel of the top-emitting display area 12 sequentially comprises a first electrode 121, at least one first organic functional 122 layer and a second electrode 123. The first electrode 121 is disposed on the transparent substrate 11, and the active driving circuit 124 comprises at least one capacitor and at least two thin-film transistors (not shown). Thus, the active driving circuit 124 can actively drive the top-emitting display area 12 as shown in FIG. 2. The light emitted form the top-emitting display area 12 upwardly passes through the second electrode 123. The pixel of the bottom-emitting display area 13 sequentially comprises a third electrode 131, at least one second organic functional layer 132 and a fourth electrode 133. The light emitted form the bottom-emitting display area 13 downwardly passes through the third electrode 131 and the transparent substrate 11.

In the present embodiment, the transparent substrate 11 can be a flexible or a rigid substrate. The transparent substrate 11 can also be a plastic or glass substrate. In particular, the flexible substrate or plastic substrate comprises polycarbonate (PC), polyester (PET), cyclic olefin copolymer (COC), and metallocene-based cyclic olefin copolymer (mCOC).

Herein, the first electrode 121 is disposed on the transparent substrate 11 by way of evaporation or sputtering. The first electrode 121 is usually used as an anode and made of the material selected from the group consisting of aluminum, calcium, magnesium, indium, zinc, manganese, silver, gold and magnesium alloy. The magnesium alloy can be, for example, Mg:Ag alloy, Mg:In alloy, Mg:Sn alloy, Mg:Sb alloy and Mg:Te alloy.

The first organic functional layer 122 is usually selected from one or the combination of hole-injecting layer, hole-transporting layer, electroluminescent layer, electron-transporting layer and electron-injecting layer (not shown). The first organic functional layer 122 can be formed over the first electrode 121 by utilizing evaporation, spin coating, ink jet printing or printing. In addition, the light emitted from the first organic functional layer 122 can be blue, green, red, white, other monochromatic light, or a color light as a combination of monochromatic lights.

The second electrode 123 is disposed over the first organic functional layer 122. Herein, the second electrode 123 can be formed over the first organic functional layer 122 by sputtering or ion plating. The second electrode 123 is usually used as a cathode and made of a transparent conductive metal oxide, such as indium-tin oxide (ITO), aluminum-zinc oxide (AZO) or indium-zinc oxide (IZO).

Referring to FIG. 2 again, the bottom-emitting display area 13 is disposed over the transparent substrate 11 and comprises a plurality of pixels and a passive driving circuit 134. The pixel of the bottom-emitting display area 13 sequentially comprises a third electrode 131, at least one second organic functional 132 layer and a fourth electrode 133. The third electrode 131 is disposed over the transparent substrate 11, and the passive driving circuit 134 drives the pixel of the bottom-emitting display area 13 according to a column and row scan. Thus, the passive driving circuit 134 can passively drive the bottom-emitting display area 13, and the light emitted form the bottom-emitting display area 13 downwardly passes through the third electrode 131 and the transparent substrate 11.

In this case, the features and functions of the third electrode 131, the second organic functional layer 132 and the fourth electrode 133 are respectively the same with the second electrode 123, the first organic functional layer 122, and the first electrode 121 described previously, so that the detailed descriptions are omitted here for concise purpose.

The configuration and the sizes of the top-emitting display area 12 and the bottom-emitting display area 13 can also be adjusted according to the demands.

In addition, the dual display device 1 of the embodiment may further comprise a cover plate 17, which is incorporated with the transparent substrate 11 via an adhesive (not shown). Dark spots may be formatted when the display areas contact with air since the organic functional layers of the top-emitting display area 12 and the bottom-emitting display area 13 are very sensitive to moisture and oxygen. Thus, the cover plate 17 is applied to prevent the top-emitting display area 12 and the bottom-emitting display area 13 from being degraded by moisture and oxygen.

Moreover, the dual display device 1 of the embodiment my further comprise a drying unit 18, which is disposed in the space formed by the cover plate 17 and the transparent substrate 11. Herein, the drying unit 18 is disposed on the cover plate 17 and is disposed at the periphery of the top-emitting display area 12 and the bottom-emitting display area 13. In this case, the drying unit 18 can be a desiccant for absorbing the water contained in the space after encapsulation. This can efficiently prolong the lifetime of the dual display device. In addition, the drying unit can be directly disposed on the second electrode and/or the fourth electrode, and a buffer layer (not shown) can further be disposed between the drying unit and the second electrode and/or the fourth electrode. Herein, the drying unit 18 may comprise materials, such as barium oxide (BaO) or other material suitable for absorbing water and oxygen. The buffer layer can be liquid curable adhesive, such as a heat-cured adhesive or an UV cured adhesive.

Furthermore, the dual display device 1 of the embodiment may further comprise a transparent passivation layer (not shown), which is disposed over the transparent substrate 11, the top-emitting display area 12 and the bottom-emitting display area 13. Herein, the transparent passivation layer is to prevent the top-emitting display area 12 and the bottom-emitting display area 13 from being degraded by moisture and oxygen.

In the current embodiment, the top-emitting display area 12 and the bottom-emitting display area 13 can use the same driving source. Herein, the top-emitting display area 12 can be used as a main-display area, which cooperates with the bottom-emitting display area 13 as a sub-display area to increase the convenience for users. In this case, the top-emitting display area 12 and the bottom-emitting display area 13 may display films, pictures or numerals according to the demands.

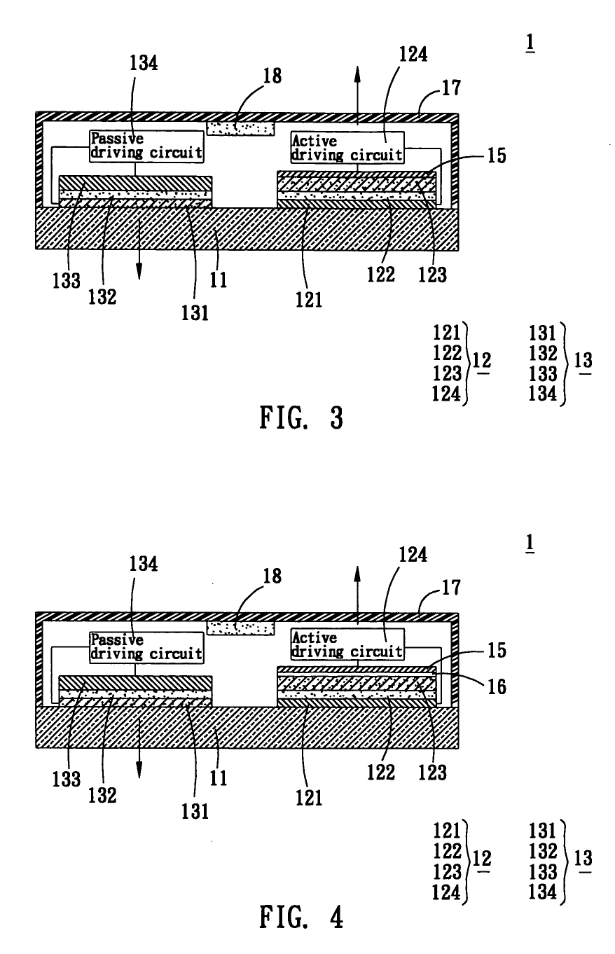

With reference to FIG. 3, the dual display device 1 according to the embodiment of the invention further comprises at least one semi-reflecting layer 15, which is disposed over the corresponding top-emitting display area 12 and/or the corresponding bottom-emitting display area 13. In the case, the semi-reflecting layer 15 is disposed over the top-emitting display area 12. Thus, when the top-emitting display area 12 does not emit light, it possesses the function of mirror. The semi-reflecting layer 15 can be formed on the top-emitting display area 12 by evaporating, sputtering or ion plating. The semi-reflecting layer 15 is made of a metal or dielectric material, and has an optical transmittance between about 10% and 90%.

As mentioned above, the thickness of the first electrode 121 is determined according to the optical transmittance of the semi-reflecting layer 15. That is, the lower the optical transmittance of the semi-reflecting layer 15 is, the thicker the first electrode 121 is. Thus, the light generated by the first organic functional layer 122 can pass through the semi-reflecting layer 15 easier.

To be noted, when the semi-reflecting layer 15 is made of a metal, an insulating layer 16 (as shown in FIG. 4) is further disposed between the semi-reflecting layer 15 and the second electrode 123 of the top-emitting display area 12. The insulating layer 16 is a transparent material for insulating the semi-reflecting layer 15 and the second electrode 123. This configuration prevents the semi-reflecting layer 15 and the second electrode 123 from short circuit.

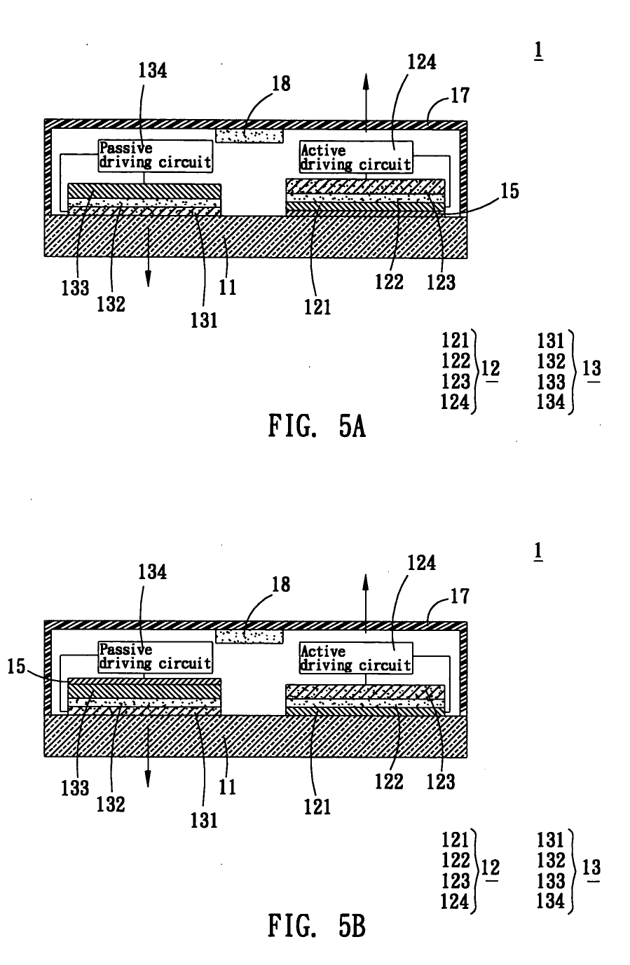

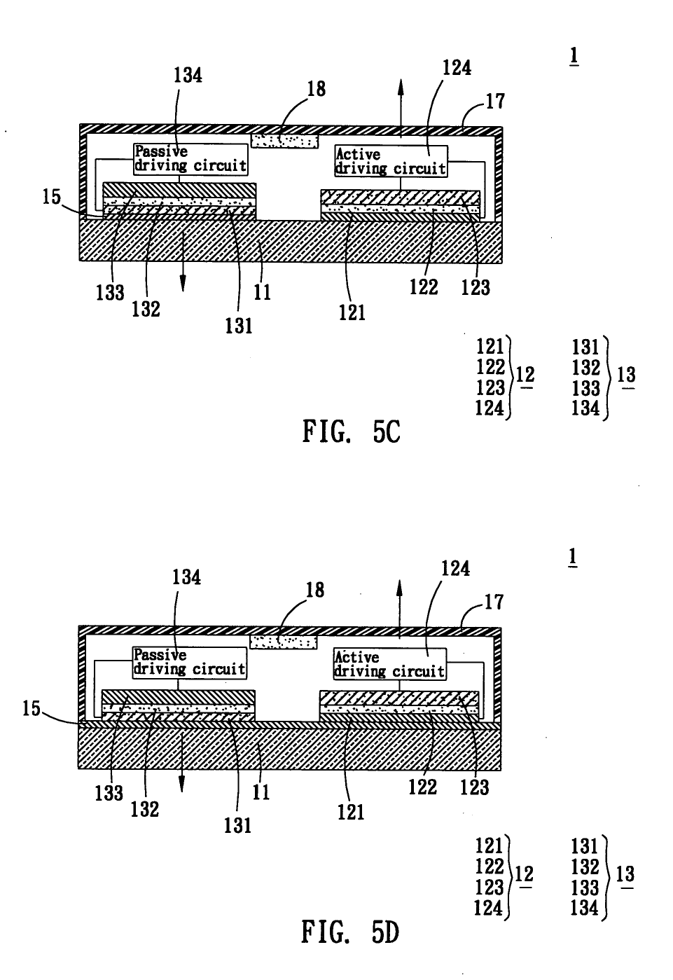

In addition, the semi-reflecting layer 15 can be disposed below the top-emitting display area 12, above the bottom-emitting display area 13, below the bottom-emitting display area 13, on the transparent substrate 11, or under the transparent substrate 11, as shown in FIGS. 5A to 5E. Besides, the dual display device of the invention may further comprise a plurality of semi-reflecting layers, which are respectively disposed over the corresponding top-emitting display area and the corresponding bottom-emitting display area. The configurations of the semi-reflecting layers are the same as the previously mentioned. To prevent the short circuit between the semi-reflecting layer and the top-emitting display area and/or the bottom-emitting display area, the dual display device of the invention can further comprise a plurality of insulating layers, which are respectively disposed at one side of the semi-reflecting layers.

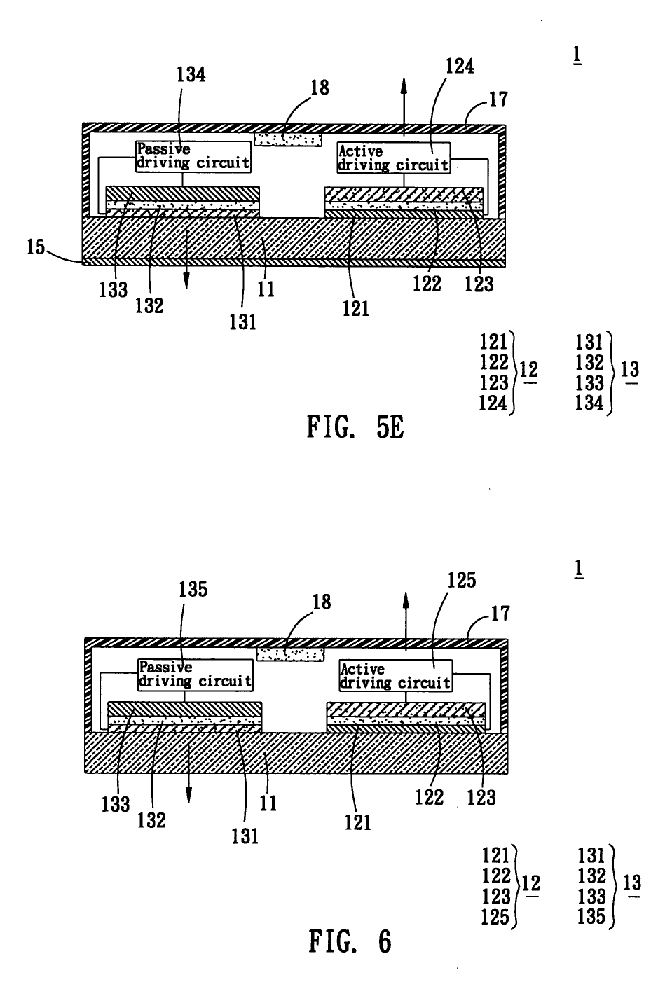

With reference to FIG. 6, the top-emitting display area 12 of the embodiment may comprise a passive driving circuit 125, and the bottom-emitting display area 13 of the embodiment may comprise an active driving circuit 135. Herein, the pixel of the top-emitting display area 12 can be passively driven, and the pixel of the bottom-emitting display area 13 can be actively driven. In the embodiment, the bottom-emitting display area 13 is used as a main-display area, and the top-emitting display area 12 is used as a sub-display area. Other elements of this embodiment is the same to those described in the previously embodiment, so the detailed descriptions are omitted here for concise purpose.

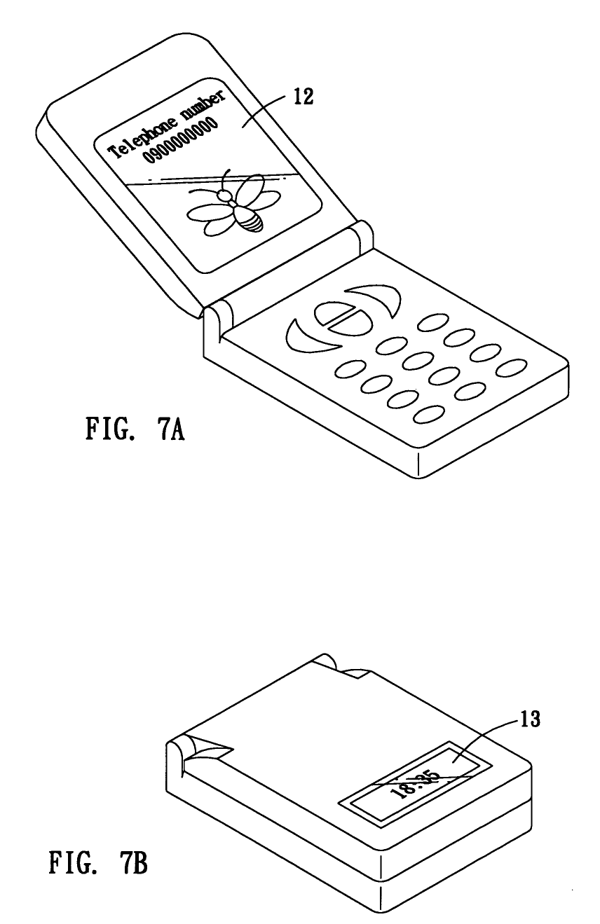

Hereinafter, an example is described, wherein the dual display device is embodied in a mobile phone, referring to FIGS. 7A and 7B. Wherein, FIGS. 7A and 7B are schematic views showing an application of the dual display device 1 shown in FIG. 2A. As shown in FIG. 7A, when a user opens the mobile phone, the top-emitting display area 12 (the main-display area) displays the caller ID and related information. In addition, as shown in FIG. 7B, when the user closes the mobile phone, the bottom-emitting display area 13 (the sub-display area) displays different information, such as the local time, from that displayed on the top-emitting display area 12. Of course, the bottom-emitting display area 13 may display the same information or partially same information as that displayed on the top-emitting display area 12. In this case, the image information of the top-emitting display area 12 is transmitted or partially transmitted to the bottom-emitting display area 13. The image information shown on the bottom-emitting display area 13 is transformed to the orientation directly facing the user's eyes.

In the present embodiment wherein the dual display device comprises at least one semi-reflecting layer, when the top-emitting display area 12 and the bottom-emitting display area 13 emit light, the user can see the displayed images of the top-emitting display area 12 and the bottom-emitting display area 13, such as words, numbers, pictures or images. On the other hand, when the top-emitting display area 12 and/or the bottom-emitting display area 13 do not emit light, the user can see the reflected image opposite to the display areas. That is, the top-emitting display area 12 and/or the bottom-emitting display area 13 are used as a mirror.

### Second Embodiment

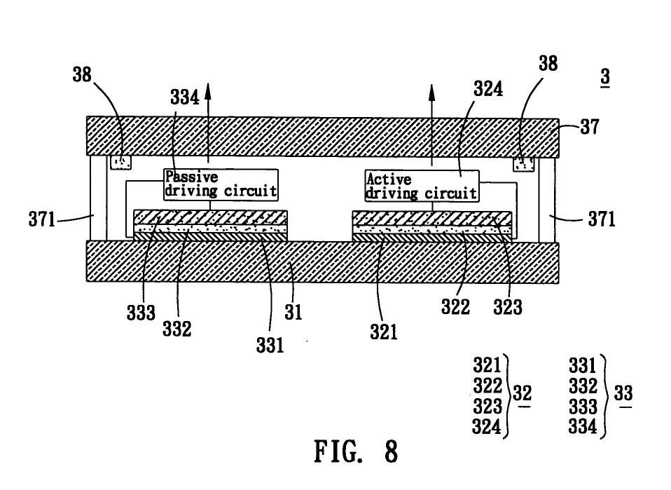

With reference to FIG. 8, a dual display device 3 according to the second embodiment of the invention comprises a transparent substrate 31, a first top-emitting display area 32 and a second top-emitting display area 33.

In this case, the first top-emitting display area 32 is disposed over the transparent substrate 31 and comprises a plurality of pixels and an active driving circuit 324. The second top-emitting display area 33 is disposed over the transparent substrate 31 and comprises a plurality of pixels and a passive driving circuit 334. The pixel of the first top-emitting display area 32 sequentially comprises a first electrode 321, at least one first organic functional 322 layer and a second electrode 323. The light emitted form the first top-emitting display area 32 upwardly passes through the second electrode 323. The pixel of the second top-emitting display area 33 sequentially comprises a third electrode 331, at least one second organic functional layer 332 and a fourth electrode 333. The light emitted from the second top-emitting display area 33 upwardly passes through the fourth electrode 333.

In this case, the features and functions of the transparent substrate 31, the first electrode 321, the first organic functional layer 322, the second electrode 323, the third electrode 331, the second organic functional layer 332 and the fourth electrode 333 are the same with the transparent substrate 11, the first electrode 121, the first organic functional layer 122, the second electrode 123, the first electrode 121, the first organic functional layer 122 and the second electrode 123, respectively described previously with reference to FIG. 2, so the detailed descriptions are omitted here for concise purpose. That is, the features and functions of the first and second top-emitting display areas 32, 33 are the same to those of the top-emitting display area 12.

With reference to FIG. 8, the active driving circuit 324 comprises at least one capacitor and at least two thin-film transistors (not shown). Thus, the active driving circuit 324 can actively drive the pixel of the first top-emitting display area 32. The passive driving circuit 334 drives the pixel of the second top-emitting display area 33 according to a column and row scan. Thus, the passive driving circuit 334 can passively drive the pixel of the second top-emitting display area 33.

The configuration and the sizes of the first top-emitting display area 32 and the second top-emitting display area 33 can also be adjusted according to the demands.

In addition, the dual display device 3 of the embodiment may further comprise a cover plate 37, which is incorporated with the transparent substrate 31 via an adhesive 371. The features and functions of the cover plate 37 and the adhesive 371 are the same with the cover plate 17 and the adhesive described previously, so the detailed descriptions are omitted here for concise purpose.

Moreover, the dual display device 3 of the embodiment my further comprise a drying unit 38, which is disposed in the space formed by the cover plate 37 and the transparent substrate 31. Herein, the features and functions of the drying unit 38 are the same with the drying unit 18 described previously, so the detailed descriptions are omitted here for concise purpose.

Furthermore, the dual display device 3 of the embodiment may further comprise a transparent passivation layer (not shown), which is disposed over the transparent substrate 31, the first top-emitting display area 32 and the second top-emitting display area 33. Herein, the transparent passivation layer is to prevent the first top-emitting display area 32 and the second top-emitting display area 33 from being degraded by moisture and oxygen.

In the current embodiment, the first top-emitting display area 32 and the second top-emitting display area 33 can use the same driving source. Herein, the first top-emitting display area 32 can be used as a main-display area, which cooperates with the second top-emitting display area 33 as a sub-display area to increase the convenience for users. In this case, the first top-emitting display area 32 and the second top-emitting display area 33 may display films, pictures or numerals according to the demands.

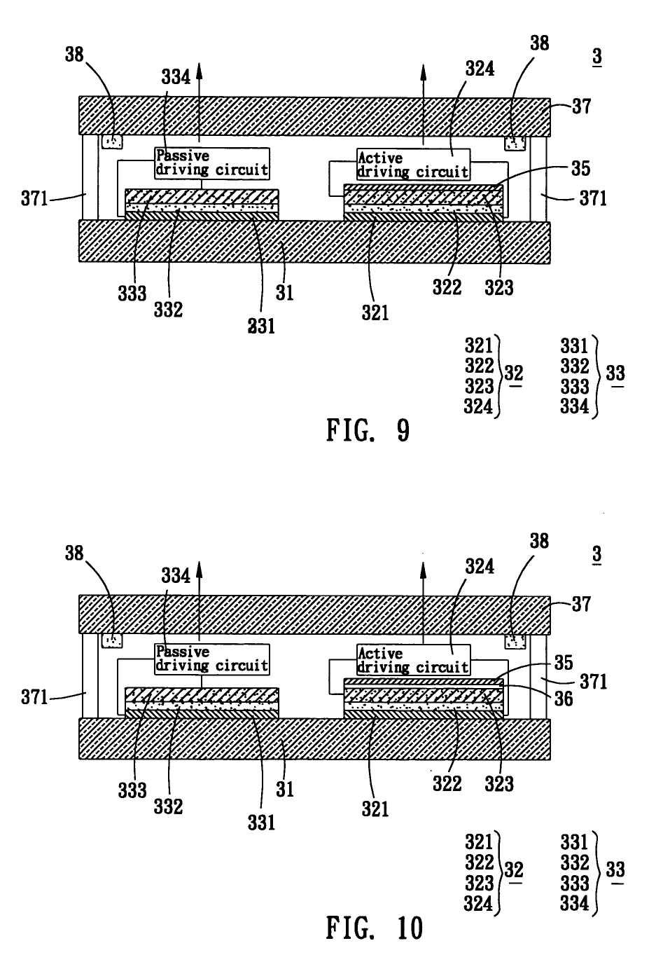

With reference to FIG. 9, the dual display device 3 according to the embodiment of the invention further comprises at least one semi-reflecting layer 35, which is disposed over the corresponding first top-emitting display area 32 and/or the corresponding second top-emitting display area 33. In the case, the semi-reflecting layer 35 is disposed over the first top-emitting display area 32. Thus, when the first top-emitting display area 32 does not emit light, it possesses the function of mirror. The semi-reflecting layer 35 can be formed over the first top-emitting display area 32 by evaporating, sputtering or ion plating. The semi-reflecting layer 35 is made of a metal or dielectric material, and has an optical transmittance between about 10% and 90%.

As mentioned above, the thickness of the first electrode 321 is determined according to the optical transmittance of the semi-reflecting layer 35. That is, the lower the optical transmittance of the semi-reflecting layer 35 is, the thicker the first electrode 321 is. Thus, the light generated by the first organic functional layer 322 can pass through the semi-reflecting layer 35 easier than passing through the first electrode 321.

When the semi-reflecting layer 35 is made of a metal, an insulating layer 36 (as shown in FIG. 10) is further disposed between the semi-reflecting layer 35 and the second electrode 323 of the first top-emitting display area 32. The insulating layer 36 is a transparent material for insulating the semi-reflecting layer 35 and the second electrode 323. This configuration prevents the semi-reflecting layer 35 and the second electrode 323 from short circuit.

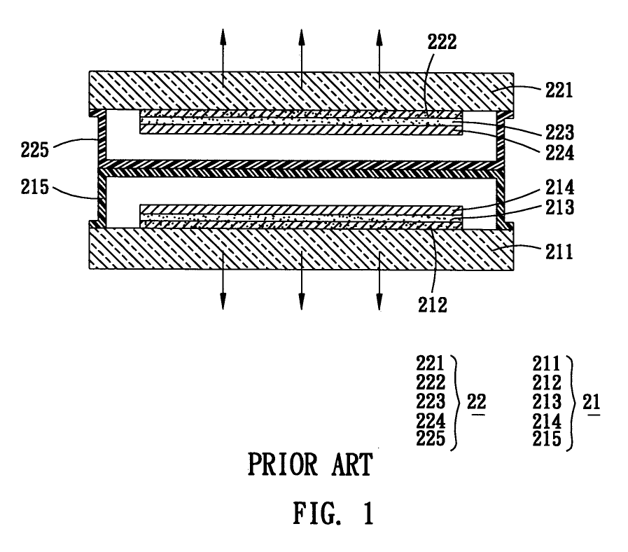

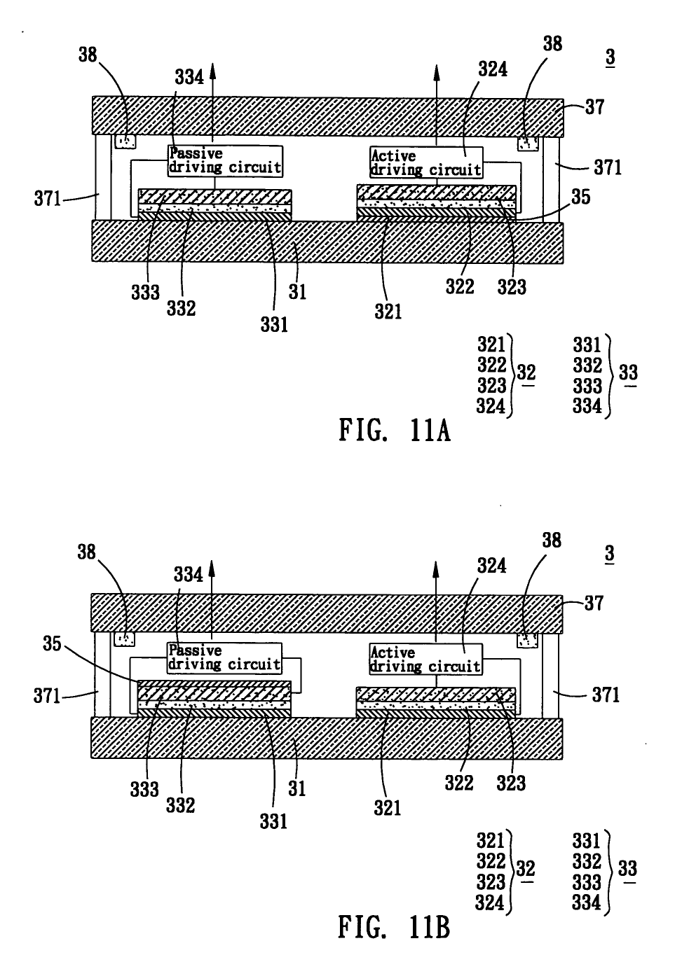

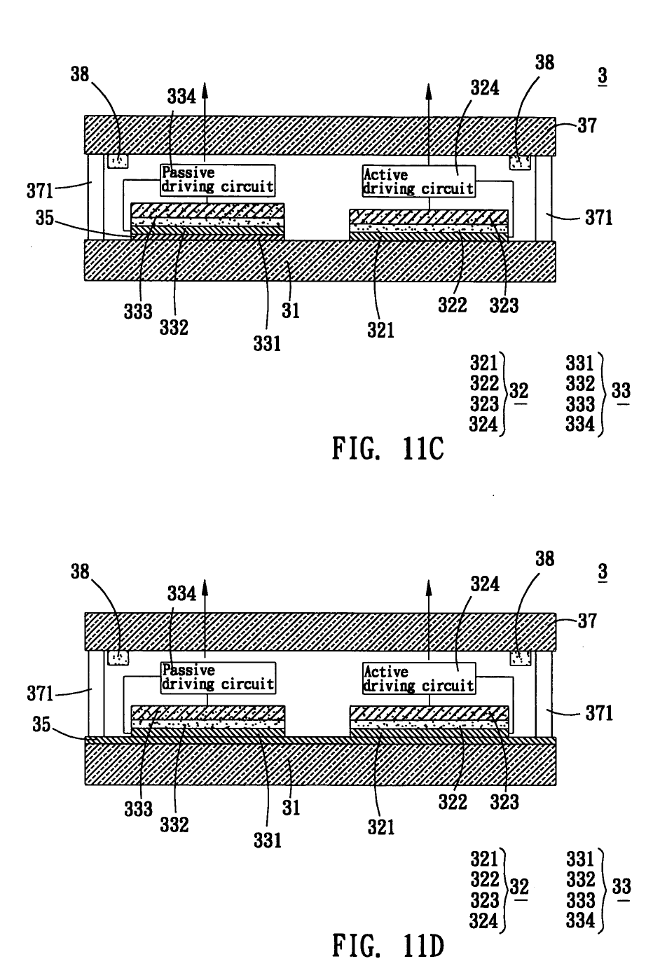

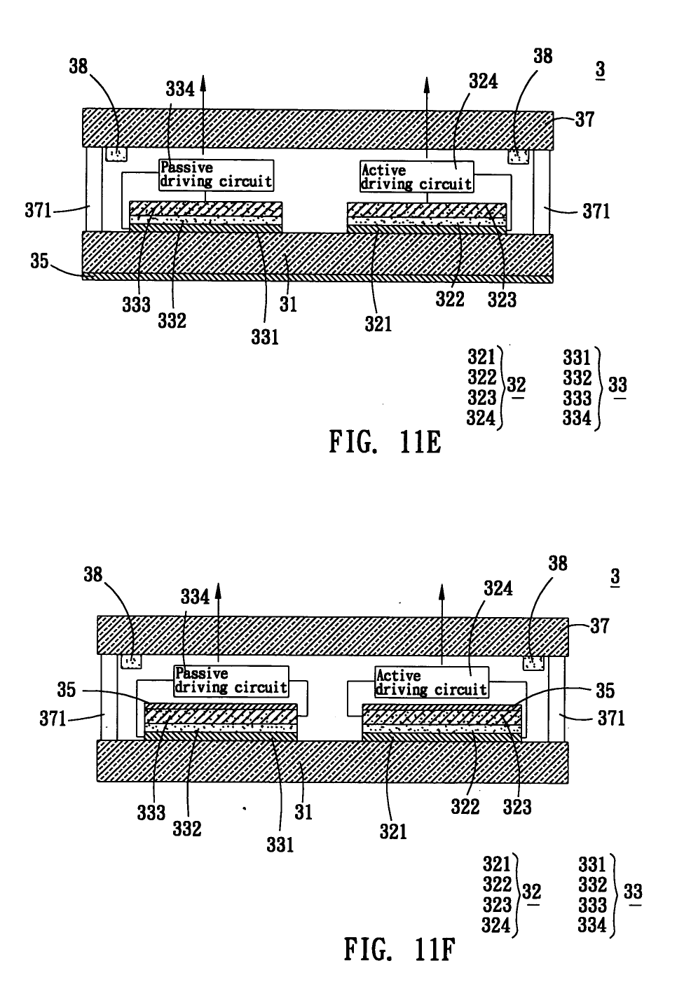

In addition, the semi-reflecting layer 35 can be disposed below the first top-emitting display area 32, above the second top-emitting display area 33, below the second top-emitting display area 33, on the transparent substrate 11, or under the transparent substrate 11, as shown in FIGS. 1A to 11E. Besides, the dual display device of the invention may further comprise a plurality of semi-reflecting layers, which are respectively disposed over the corresponding first top-emitting display area and the corresponding second top-emitting display area. The configurations of the semi-reflecting layers can be the combinations of those previously mentioned. For example, the semi-reflecting layers can be disposed over the first top-emitting display area 32 and over the second top-emitting display area 33, as shown in FIG. 11F. To prevent the short circuit between the semi-reflecting layer and the first top-emitting display area and/or the second top-emitting display area, the dual display device of the invention can further comprise a plurality of insulating layers, which are respectively disposed at one side of the semi-reflecting layers.

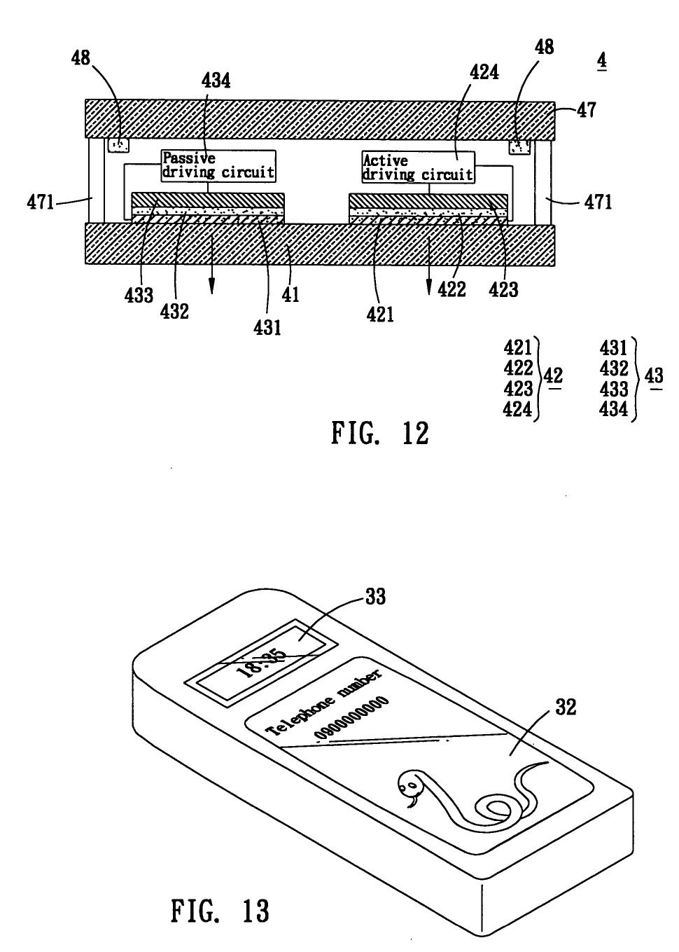

With reference to FIG. 12, a dual display device 4 according to the second embodiment of the invention comprises a transparent substrate 41, a first bottom-emitting display area 42 and a second bottom-emitting display area 43.

In this case, the first bottom-emitting display area 42 is disposed over the transparent substrate 41 and comprises a plurality of pixels and an active driving circuit 424. The second bottom-emitting display area 43 is disposed over the transparent substrate 41 and comprises a plurality of pixels and a passive driving circuit 434. The pixel of the first bottom-emitting display area 42 sequentially comprises a first electrode 421, at least one first organic functional 422 layer and a second electrode 423. The light emitted form the first bottom-emitting display area 42 downwardly passes through the first electrode 421 and the transparent substrate 41. The pixel of the second bottom-emitting display area 43 sequentially comprises a third electrode 431, at least one second organic functional layer 432 and a fourth electrode 433. The light emitted form the second bottom-emitting display area 43 downwardly passes through the third electrode 431 and the transparent substrate 41.

In this case, the features and functions of the transparent substrate 41, the first electrode 421, the first organic functional layer 422, the second electrode 423, the third electrode 431, the second organic functional layer 432 and the fourth electrode 433 are the same with the transparent substrate 11, the third electrode 131, the second organic functional layer 132, the fourth electrode 133, the third electrode 131, the second organic functional layer 132, and the fourth electrode 133, respectively described previously with reference to FIG. 2, so the detailed descriptions are omitted here for concise purpose. That is, the features and functions of the first and second bottom-emitting display areas 42, 43 are the same to those of the bottom-emitting display area 13.

The active driving circuit 424 comprises at least one capacitor and at least two thin-film transistors (not shown). Thus, the active driving circuit 424 can actively drive the pixel of the first bottom-emitting display area 42. The passive driving circuit 434 drives the pixel of the second bottom-emitting display area 43 according to a column and row scan. Thus, the passive driving circuit 434 can passively drive the pixel of the second bottom-emitting display area 43.

The configuration and the sizes of the first bottom-emitting display area 42 and the second bottom-emitting display area 43 can also be adjusted according to the demands.

In addition, the dual display device 4 of the embodiment may further comprise a cover plate 47, an adhesive 471 and a drying unit 48. The features and functions of the cover plate 47, the adhesive 471 and the drying unit 48 are the same with the cover plate 37, the adhesive 371 and the drying unit 38 described previously, so the detailed descriptions are omitted here for concise purpose.

As mentioned above, the dual display device 4 according to the embodiment of the invention further comprises at least one semi-reflecting layer (not shown), which is disposed at one side of the first bottom-emitting display area 42 and/or the second bottom-emitting display area 43. Thus, when the first bottom-emitting display area 42 and/or the second bottom-emitting display area 43 does not emit light, it possesses the function of mirror. The semi-reflecting layer can be formed by evaporating, sputtering or ion plating. The semi-reflecting layer is made of a metal or dielectric material, and has an optical transmittance between about 10% and 90%. The configurations of the semi-reflecting layer are described previously, so the detailed descriptions are omitted here for concise purpose.

Hereinafter, an example is described, wherein the dual display device is embodied in a mobile phone, referring to FIG. 13. Wherein, FIG. 13 is a schematic view showing an application of the dual display device 3 shown in FIG. 8. As shown in FIG. 13, when a user opens the mobile phone, the first top-emitting display area 32 (the main-display area) displays the major information such as the telephone function page, the telephone number of the caller, the identification of the caller, and images. In addition, the second top-emitting display area 33 (the sub-display area) displays the minor information, which is different information, such as the local time, from that displayed in the first top-emitting display area 32.

In the current embodiment wherein the dual display device comprises at least one semi-reflecting layer, when the first top-emitting display area 32 and the second top-emitting display area 33 emit light, the user can see the displayed images of the first top-emitting display area 32 and the second top-emitting display area 33, such as words, numbers, pictures or images. On the other hand, when the first top-emitting display area 32 and/or the second top-emitting display area 33 does not emit light, the user can see the reflected image opposite to the display areas. That is, the first top-emitting display area 32 and/or the second top-emitting display area 33 is used as a mirror.

### Third Embodiment

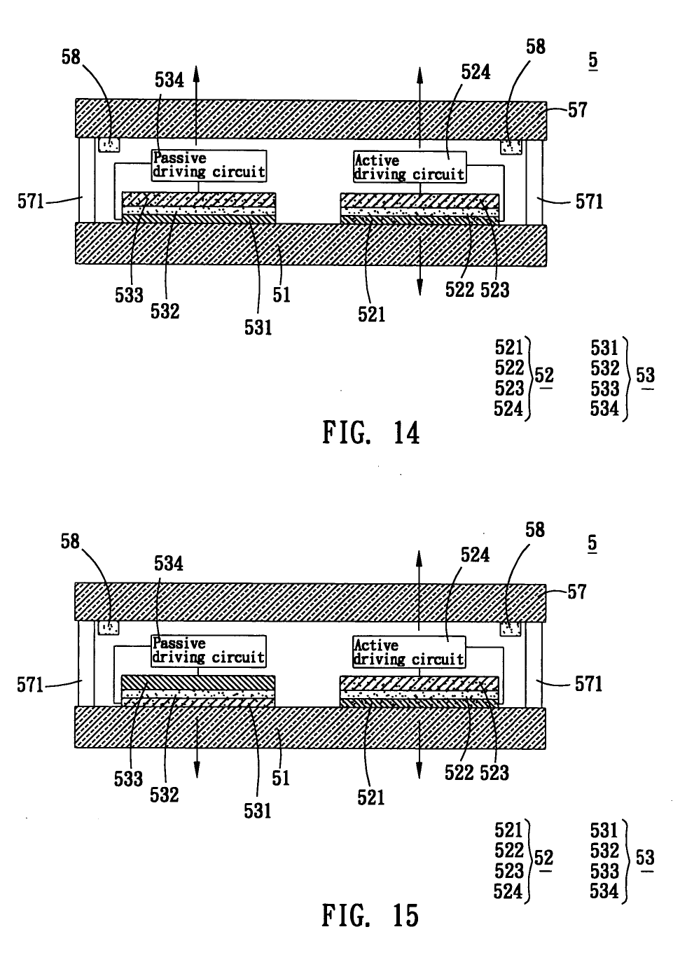

With reference to FIG. 14, a dual display device 5 according to the third embodiment of the invention comprises a transparent substrate 51, a first transparent display area 52 and a second display area 53.

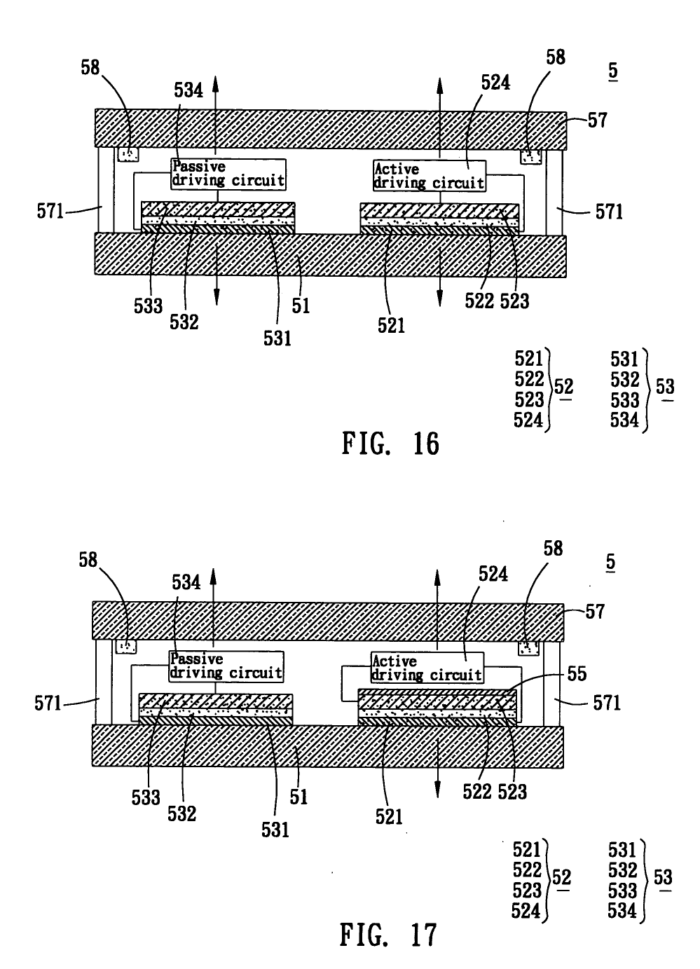

In the embodiment, the first transparent display area 52 is disposed over the transparent substrate 51. The first transparent display area 52 comprises a plurality of pixels and an active driving circuit 524. The second display area 53 is disposed over the transparent substrate 51 and comprises a plurality of pixels and a passive driving circuit 534. The pixel of the first transparent display area 52 sequentially comprises a first electrode 521, at least one first organic functional 522 layer and a second electrode 523. The light emitted form the first transparent display area 52 upwardly passes through the second electrode 523 and downwardly passes through the first electrode 521 and the transparent substrate 51. The pixel of the second display area 53 sequentially comprises a third electrode 531, at least one second organic functional layer 532 and a fourth electrode 533. As shown in FIG. 14, the second display area 53 is a top-emitting display area, wherein the light emitted from the second display area 53 upwardly passes through the fourth electrode 533 as shown in FIGS. 15 and 16. The second display area 53 can be a bottom-emitting display area, so that the light emitted from the second display area 53 downwardly passes through the third electrode 531 and the transparent substrate 51 (as shown in FIG. 15). In addition, the second display area 53 can be a transparent display area, so that the light emitted from the second display area 53 upwardly passes through the fourth electrode 533 and downwardly passes through the third electrode 531 and the transparent substrate 51.

The first transparent display area 52 comprises a plurality of pixels and an active driving circuit 524. The pixel of the first transparent display area 52 sequentially comprises a first electrode 521, at least one first organic functional 522 layer and a second electrode 523. The first electrode 521 is disposed over the transparent substrate 51, and the active driving circuit 524 comprises at least one capacitor and at least two thin-film transistors (not shown). Thus, the active driving circuit 524 can actively drive the first transparent display area 52 as shown in FIG. 14.

Herein, the first electrode 521 is formed over the transparent substrate 51 by sputtering or ion plating. The first electrode 521 is made of a transparent conductive metal oxide, such as indium-tin oxide (ITO), aluminum-zinc oxide (AZO), indium-zinc oxide (IZO) or cadmium-Stannum oxide (CdSnO).

The first organic functional layer 522 is usually selected from one or the combination of hole-injecting layer, hole-transporting layer, electroluminescent layer, electron-transporting layer and electron-injecting layer (not shown). The first organic functional layer 522 can be formed over the first electrode 521 by utilizing evaporation, spin coating, ink jet printing or printing. In addition, the light emitted from the first organic functional layer 522 can be blue, green, red, white, other monochromatic light, or a color light as a combination of monochromatic lights.

The second electrode 523 is disposed over the first organic functional layer 522. Herein, the second electrode 523 can be formed over the first organic functional layer 522 by sputtering or ion plating. The second electrode 523 is usually made of a transparent conductive metal oxide, such as indium-tin oxide (ITO), aluminum-zinc oxide (AZO), indium-zinc oxide (IZO) or cadmium-Stannum oxide (CdSnO).

Referring to FIG. 14 again, the second display area 53 is a top-emitting display area and is disposed over the transparent substrate 51. The second display area 53 comprises a plurality of pixels and a passive driving circuit 534. The pixel of the second display area 53 sequentially comprises a third electrode 531, at least one second organic functional 532 layer and a fourth electrode 533. The third electrode 531 is disposed over the transparent substrate 51, and the passive driving circuit 534 drives the pixel of the second display area 53 according to a column and row scan. Thus, the passive driving circuit 534 can passively drive the second display area 53, and the light emitted form the second display area 53 upwardly passes through the fourth electrode 533.

Herein, the third electrode 531 is disposed over the transparent substrate 51 by evaporation or sputtering. The third electrode 531 is usually used as an anode and made of the material selected from the group consisting of aluminum, calcium, magnesium, indium, zinc, manganese, silver, gold and magnesium alloy. The magnesium alloy can be, for example, Mg:Ag alloy, Mg:In alloy, Mg:Sn alloy, Mg:Sb alloy and Mg:Te alloy.

The second organic functional layer 532 is usually selected from one or the combination of hole-injecting layer, hole-transporting layer, electroluminescent layer, electron-transporting layer and electron-injecting layer (not shown). The second organic functional layer 532 can be disposed over the third electrode 531 by utilizing evaporation, spin coating, ink jet printing or printing. In addition, the light emitted from the second organic functional layer 532 can be blue, green, red, white, other monochromatic light, or a color light as a combination of monochromatic lights.

The fourth electrode 533 is disposed over the second organic functional layer 532. Herein, the fourth electrode 533 can be formed over the second organic functional layer 532 by sputtering or ion plating. The fourth electrode 533 is usually used as a cathode and made of a transparent conductive metal oxide, such as indium-tin oxide (ITO), aluminum-zinc oxide (AZO), indium-zinc oxide (IZO) or cadmium-Stannum oxide (CdSnO).

The configuration and the sizes of the first transparent display area 52 and the second display area 53 can also be adjusted according to the demands.

In addition, the dual display device 5 of the embodiment may further comprise a cover plate 57, which is incorporated with the transparent substrate 51 via an adhesive 571. Of course, the cover plate 57 can be a flat plate as shown in FIG. 14, and it can be other shapes, such as a cap with a central cavity for encapsulating on the transparent substrate (not shown). Since the organic functional layers of the first transparent display area 52 and the second display area 53 are very sensitive to moisture and oxygen, dark spots may be formatted when the display areas contact with air. Thus, the cover plate 57 is applied to prevent the first transparent display area 52 and the second display area 53 from being degraded by moisture and oxygen.

Moreover, the dual display device 5 of the embodiment my further comprise a drying unit 58, which is disposed in the space formed by the cover plate 57 and the transparent substrate 51. Herein, the drying unit 58 is disposed on the cover plate 57 and is disposed at the periphery of the first transparent display area 52 and the second display area 53. In this case, the drying unit 58 can be a desiccant for absorbing the water contained in the space after encapsulation. This can efficiently prolong the lifetime of the dual display device. In addition, the drying unit can be directly disposed on the second electrode and/or the fourth electrode, and a buffer layer (not shown) can further be disposed between the drying unit and the second electrode and/or the fourth electrode. Herein, the drying unit 58 may comprise materials, such as barium oxide (BaO) or other material suitable for absorbing water and oxygen. The buffer layer can be liquid curable adhesive, such as a heat-cured adhesive or an UV cured adhesive.

Furthermore, the dual display device 5 of the embodiment may further comprise a transparent passivation layer (not shown), which is disposed over the transparent substrate 51, the first transparent display area 52 and the second display area 53. Herein, the transparent passivation layer is to prevent the first transparent display area 52 and the second display area 53 from being degraded by moisture and oxygen.

In the current embodiment, the first transparent display area 52 and the second display area 53 can use the same driving source. Herein, the first transparent display area 52 can be used as a main-display area, which cooperates with the second display area 53 as a sub-display area to increase the convenience for users. In this case, the first transparent display area 52 and the second display area 53 may display films, pictures or numerals according to the demands.

With reference to FIG. 17, the dual display device 5 according to the embodiment of the invention further comprises at least one semi-reflecting layer 55, which is disposed over the corresponding first transparent display area 52 and/or the corresponding second display area 53. In the case, the semi-reflecting layer 55 is disposed over the first transparent display area 52. Thus, when the first transparent display area 52 does not emit light, it possesses the function of mirror. The semi-reflecting layer 55 can be formed over the first transparent display area 52 by evaporating, sputtering or ion plating. The semi-reflecting layer 55 is made of a metal or dielectric material, and has an optical transmittance between about 10% and 90%.

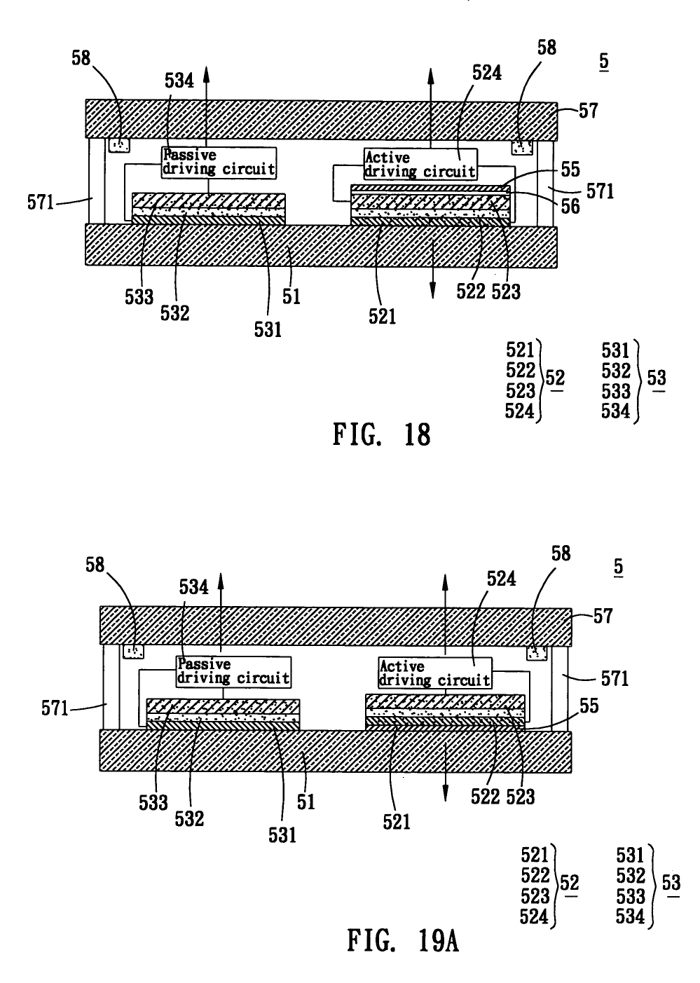

When the semi-reflecting layer 55 is made of a metal, an insulating layer 56 (as shown in FIG. 18) is further disposed between the semi-reflecting layer 55 and the second electrode 523 of the first transparent display area 52. The insulating layer 56 is a transparent material for insulating the semi-reflecting layer 55 and the second electrode 523. This configuration prevents the semi-reflecting layer 55 and the second electrode 523 from short circuit.

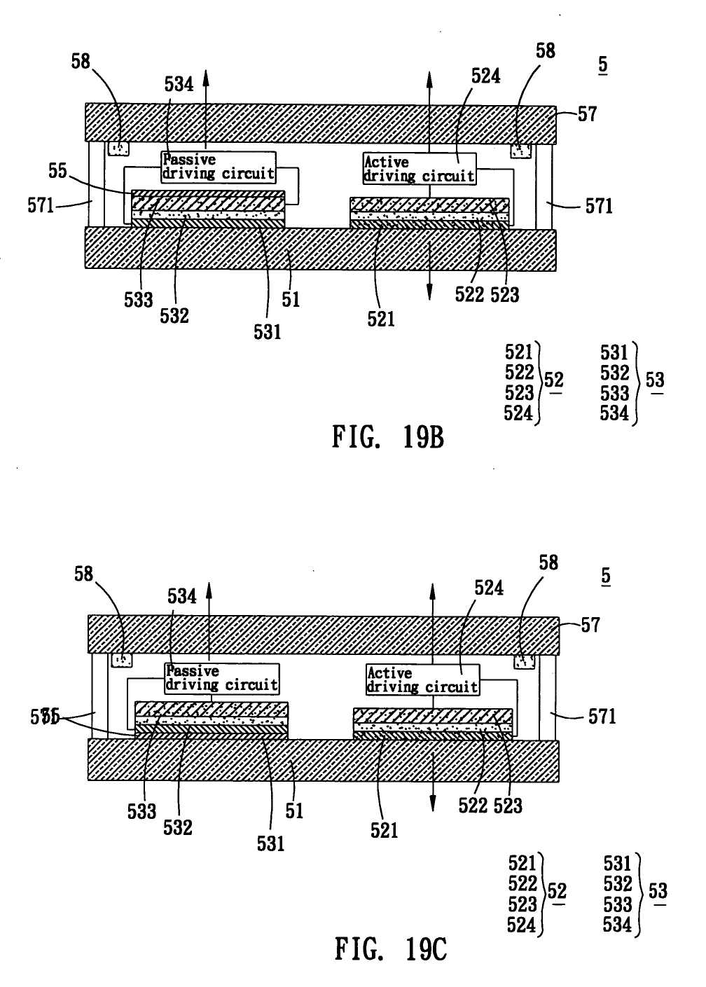

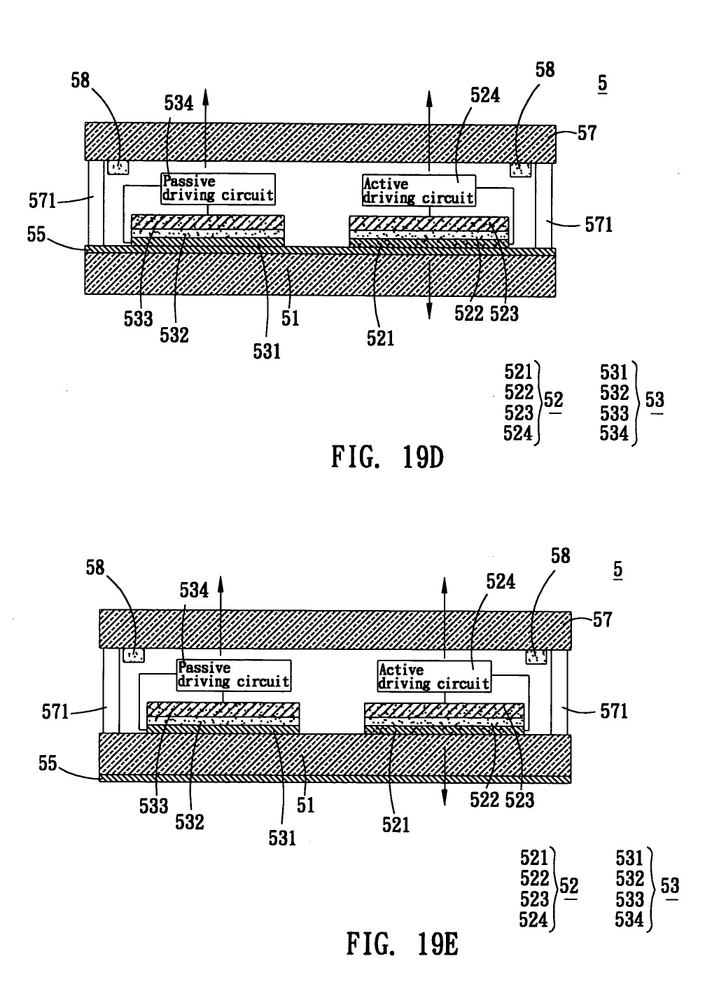

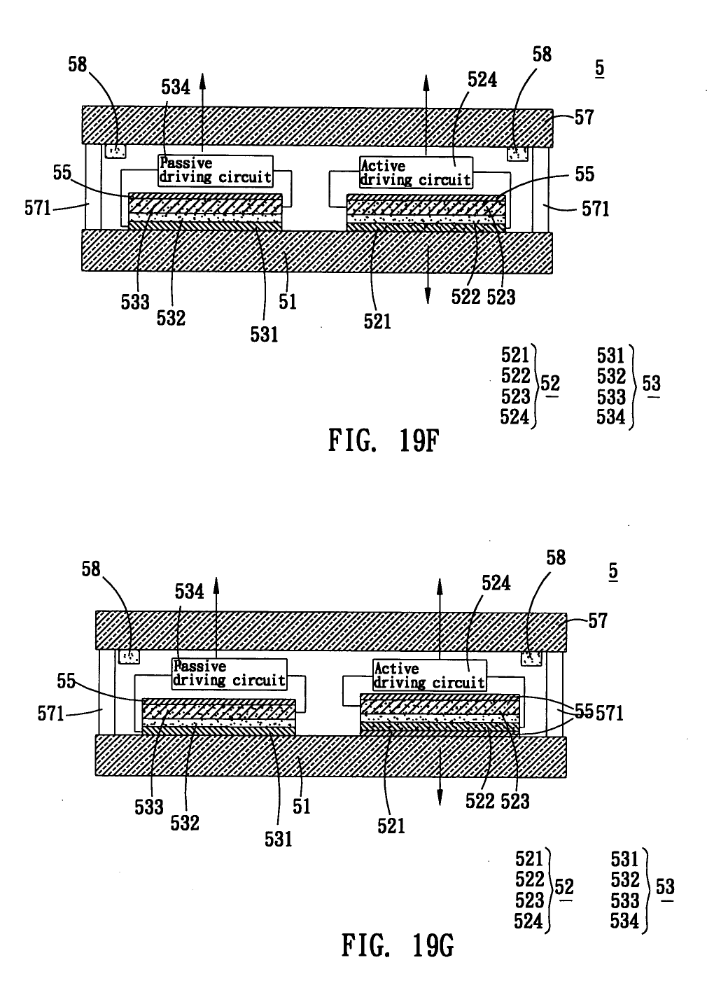

In addition, the semi-reflecting layer 55 can be disposed below the first display area 52, above the second display area 53, below the second display area 53, on the transparent substrate 51 or under the transparent substrate 51, as shown in FIGS. 19A to 19E. Besides, the dual display device of the invention may further comprise a plurality of semi-reflecting layers, which are respectively disposed over the corresponding first transparent display area and/or the corresponding second display area. The configurations of the semi-reflecting layers are the same with the previously mentioned. For example, the semi-reflecting layer 55 can be disposed above the first transparent display area 52 and above the second display area 53, as shown in FIG. 19F. In addition, the semi-reflecting layers can be disposed above the first transparent display area 52 and below the first transparent display area 52, respectively, as shown in FIG. 11G. To prevent the short circuit between the semi-reflecting layer and the first transparent display area and/or the second display area, the dual display device of the invention can further comprise a plurality of insulating layers (not shown), which are respectively disposed at one side of the semi-reflecting layers. The thickness of the electrode is determined according to the optical transmittance of the semi-reflecting layer (not shown). That is, the lower the optical transmittance of the semi-reflecting layer is, the thicker the electrode corresponding to the semi-reflecting layer is. Thus, the light generated by the organic functional layers can pass through the semi-reflecting layers easier.

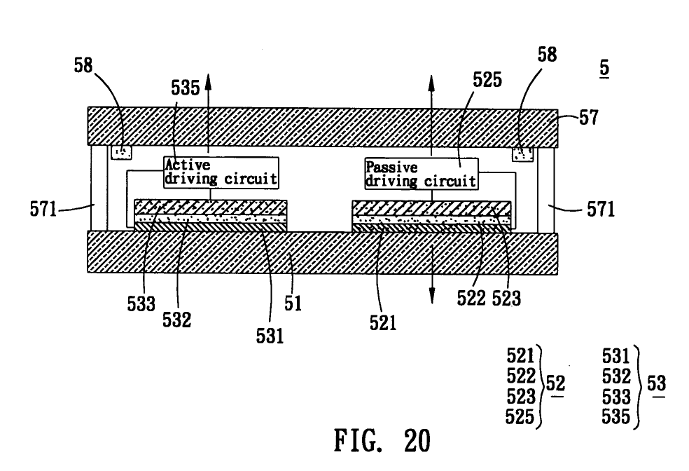

With reference to FIG. 20, the first transparent display area 52 of the embodiment may comprise a passive driving circuit 525, and the second display area 53 of the embodiment may comprise an active driving circuit 535. Herein, the pixel of the first transparent display area 52 can be passively driven, and the pixel of the second display area 53 can be actively driven. In the embodiment, the second display area 53 is used as a main-display area, and the first transparent display area 52 is used as a sub-display area. Other elements of this embodiment is the same to those described in the previously embodiment, so the detailed descriptions are omitted here for concise purpose.

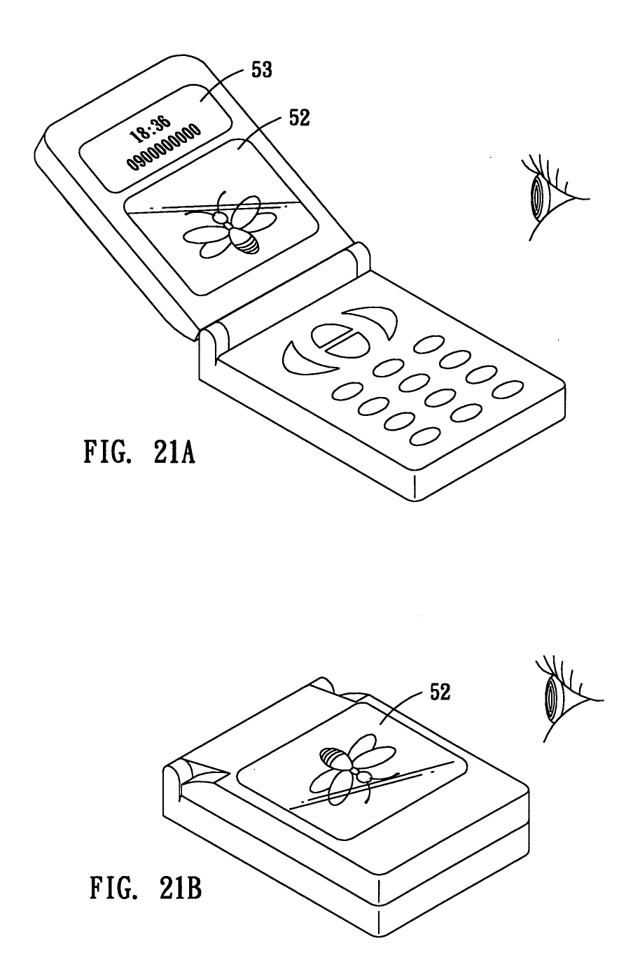

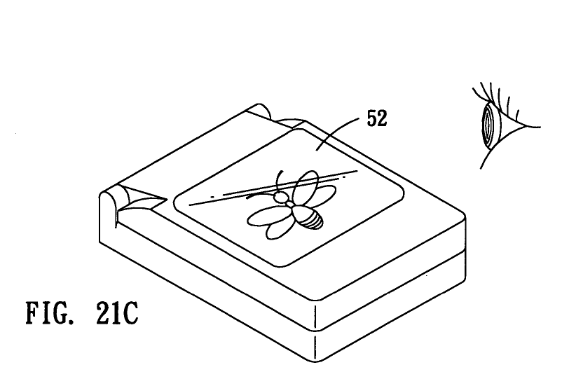

Hereinafter, an example is described, wherein the dual display device is embodied in a mobile phone, referring to FIGS. 21A and 21B. Wherein, FIGS. 21A and 21B are schematic views showing an application of the dual display device 5 shown in FIG. 14. As shown in FIG. 21A, when a user opens the mobile phone, the first transparent display area 52 (the main-display area) displays the major information such as the telephone function page and images. At the same time, the user can also see the minor information displayed on the second display area 53 (the sub-display area), which is different from that displayed on the first transparent display area 52 such as the telephone number of the caller, the identification of the caller and the local time. In addition, as shown in FIG. 21B, when the user closes the mobile phone, since the first transparent display area 52 is a transparent display area, the user can still see the information displayed thereon. Of course, the second display area 53 may display the same information or partially same information as that displayed on the first transparent display area 52. In this case, the image information of the first transparent display area 52 is transmitted or partially transmitted to the second display area 53. The image information shown on the second display area 53 is then transformed to the orientation directly facing the user's eyes.

In the present embodiment, the dual display device may further comprise an image transform module (not shown), which controls the orientation of the displayed image of the transparent display area. In other words, when the user closes the mobile phone (as shown in FIG. 21C), the image transform module may adjust the orientation of the image of the first transparent display area 52 to directly face the user's eyes.

The image transform module at least comprises a detector and an image controller. In the embodiment, the detector firstly detects the current operation situation, and transfers the detected result to the image controller. The image controller then controls the orientation of the image displayed on the first transparent display area 52.

In the present embodiment wherein the dual display device comprises at least one semi-reflecting layer, when the first transparent display area 52 and the second display area 53 emit light, the user can see the displayed images of the first transparent display area 52 and the second display area 53, such as words, numbers, pictures or images. On the other hand, when the first transparent display area 52 and/or the second display area 53 do not emit light, the user can see the reflected image opposite to the display areas. That is, the first transparent display area 52 and/or the second display area 53 are used as a mirror.

As mentioned above, the dual display device of the invention has two display areas disposed over a single transparent substrate, wherein the display areas use the same driving source to decrease the manufacturing cost. In addition, the dual display device of the invention has the function of dual sides display, is compact and lightweight, and has the features of the integrated manufacturing process. Therefore, the invention is suitable for mass production. Furthermore, cooperating with the semi-reflecting layer, both or either of the two display areas has the mirror function, which can increase the functions of the dual display device. The two display areas can respectively be actively driven and passively driven, and at least one of the display areas can be a transparent display area. Therefore, the applications and values of the dual display device can be greatly expanded.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A dual display device, comprising:
a transparent substrate;
a first display area disposed over the transparent substrate comprises a plurality of pixels and at least one active driving circuit, wherein the pixel of the first display area sequentially comprises a first electrode, at least one first organic functional layer and a second electrode, and the active driving circuit drives the pixel of the first display area; and
a second display area disposed over the transparent substrate comprises a plurality of pixels and at least one passive driving circuit, wherein the pixel of the second display area sequentially comprises a third electrode, at least one second organic functional layer and a fourth electrode, the passive driving circuit drives the pixel of the second display area, and a light-emitting direction of the first display area is in an opposite light-emitting direction of the second display area.

2. The dual display device of claim 1, wherein the first display area is a top-emitting display area and the second display area is a bottom-emitting display area, or the first display area is a bottom-emitting display area and the second display area is a top-emitting display area.

3. The dual display device of claim 1, wherein the active driving circuit comprises at least one capacitor and at least two thin-film transistors.

4. The dual display device of claim 1, wherein the passive driving circuit drives the pixel of the second display area according to a column and row scan.

5. The dual display device of claim 1, further comprising:
at least one semi-reflecting layer, which is disposed over the corresponding first display area and/or the corresponding second display area.

6. The dual display device of claim 5, further comprising:
at least one insulating layer, which is disposed at a side of the semi-reflecting layer.

7. The dual display device of claim 1, further comprising:
a cover plate, which is disposed over the transparent substrate.

8. The dual display device of claim 7, further comprising:
a drying unit, which is disposed in a space formed by the cover plate and the transparent substrate.

9. The dual display device of claim 1, further comprising:
a transparent passivation layer, which disposes over the transparent substrate, the first display area and the second display area.

10. A dual display device, comprising:
a transparent substrate;
a first display area disposed over the transparent substrate comprises a plurality of pixels and at least one active driving circuit, wherein the pixel of the first display area sequentially comprises a first electrode, at least one first organic functional layer and a second electrode, and the active driving circuit drives the pixel of the first display area; and
a second display area disposed over the transparent substrate comprises a plurality of pixels and at least one passive driving circuit, wherein the pixel of the second display area sequentially comprises a third electrode, at least one second organic functional layer and a fourth electrode, the passive driving circuit drives the pixel of the second display area, and the light-emitting directions of the first display area and the second display area are the same.

11. The dual display device of claim 10, wherein the first display area is a top-emitting display area and the second display area is a top-emitting display area, or the first display area is a bottom-emitting display area and the second display area is a bottom-emitting display area.

12. The dual display device of claim 10, wherein the active driving circuit comprises at least one capacitor and at least two thin-film transistors.

13. The dual display device of claim 10, wherein the passive driving circuit drives the pixel of the second display area according to a column and row scan.

14. The dual display device of claim 10, further comprising:
at least one semi-reflecting layer, which is disposed over the corresponding first display area and/or the corresponding second display area.

15. The dual display device of claim 10, further comprising:
a cover plate, which is disposed over the transparent substrate.

16. The dual display device of claim 10, further comprising:
a transparent passivation layer, which disposes over the transparent substrate, the first display area and the second display area.

17. A dual display device, comprising:
a transparent substrate;
a first transparent display area disposed over the transparent substrate comprises a plurality of pixels and at least one active driving circuit, wherein the pixel of the first transparent display area sequentially comprises a first electrode, at least one first organic functional layer and a second electrode, and the active driving circuit drives the pixel of the first transparent display area; and
a second display area disposed over the transparent substrate comprises a plurality of pixels and at least one passive driving circuit, wherein the pixel of the second display area sequentially comprises a third electrode, at least one second organic functional layer and a fourth electrode, and the passive driving circuit drives the pixel of the second display area.

18. The dual display device of claim 17, wherein the second display area is a top-emitting display area, a bottom-emitting display area or a transparent display area.

19. The dual display device of claim 17, further comprising:
an image transform module, which controls the orientation of a displayed image according to a user's eye.

20. The dual display device of claim 19, wherein the image transform module at least comprises a detector and an image controller.
